(19) United States
(12) Patent Application Publication
(10) Pub. No.: US 2025/0070574 A1
(43) Pub. Date: Feb. 27, 2025

(54) ACTIVE EQUALIZATION SYSTEM AND EQUALIZATION METHOD FOR BATTERY

(71) Applicant: Shenzhen CLOU Electronics CO., LTD., Shenzhen (CN)

(72) Inventors: Jin HUANG, Shenzhen (CN); Mingzhong LIU, Shenzhen (CN); Jiashuan FAN, Shenzhen (CN); Xiong CHEN, Shenzhen (CN); Shaohe ZHANG, Shenzhen (CN); Yan LI, Shenzhen (CN)

(73) Assignee: Shenzhen CLOU Electronics CO., LTD., Shenzhen, Guangdong (CN)

(21) Appl. No.: 18/645,625

(22) Filed: Apr. 25, 2024

(30) Foreign Application Priority Data
Aug. 25, 2023 (CN) 202311078458.4

(51) Int. Cl. H02J 7/00

(52) U.S. Cl. CPC H02J 7/0016; H02J 7/00304; H02J 7/00308; H02J 7/00711; H02J 7/00714

(57) ABSTRACT

Disclosed are an active equalization system and equalization method for a battery. The system includes a main control unit, a charging control unit and a discharging control unit. The main control unit is configured to receive an equalization charging instruction/equalization discharging instruction sent by an upper computer, send a first signal to the charging control unit according to the equalization charging instruction, and send a second signal to the discharging control unit according to the equalization discharging instruction. The charging control unit is configured to receive the first signal sent by the main control unit, and control the PWM startup and shutdown state of the charging MOS transistor according to the first signal. The discharging control unit is configured to receive the second signal sent by the main control unit, and control the PWM startup and shutdown state of the discharging MOS transistor according to the second signal.

### CROSS-REFERENCE TO RELATED APPLICATION

This application claims priority to Chinese Patent Application No. 202311078458.4, filed on Aug. 25, 2023, the entire contents of which are incorporated herein by reference for all purposes.

### FIELD

The present application relates to the field of battery control, and in particular to an active equalization system and an equalization method for a battery.

### BACKGROUND

With the improvement of people's requirements for environmental protection, green energy has become a pioneer in improving the environment. The application of rechargeable batteries, from power tools to pure electric vehicles, has become increasingly widespread in both consumer and industrial, and the output power required is also increasing. Since the voltage of a single rechargeable battery is limited by its own chemical characteristics, it is necessary to use batteries in series or parallel in many applications to increase the output power of the battery. Due to the materials and processes used in the manufacturing of battery cells, it is easy to experience imbalances in internal resistance, voltage and capacity during use. The more battery cells are used in series and parallel, the more serious the imbalance problem will be. The imbalance problem directly affects the output power and service cycle life of the battery pack. In order to improve the consistency of battery performance, increase the charging and discharging capacity, and extend the life of the battery system, battery energy storage systems generally use equalization technology. The ultimate purpose of equalization is to maximize the charging and discharging capacity of the energy storage system and maximize the available life of the battery.

Current equalization technologies include passive equalization and active equalization. Passive equalization technology has limited equalization ability for battery cells and is an energy-loss technology. Some existing active equalization methods have complex equalization structures, cumbersome controls, and need to improve safety. For applications with more strings, the difficulty of implementation increases. Therefore, how to simplify the equalization structure of active equalization and improve the security of active equalization is an urgent problem to be solved.

### SUMMARY

The present application provides an active equalization system and an equalization method for a battery to solve at least the problem of how to simplify the equalization structure of active equalization and improve the safety of active equalization.

In order to solve the above technical problems, the present application provides an active equalization system for a battery, including:
a main control unit, configured to receive an equalization charging instruction/equalization discharging instruction sent by an upper computer;
a charging control unit, wherein the main control unit is configured to send a first signal to the charging control unit according to the equalization charging instruction, the charging control unit is configured to receive the first signal sent by the main control unit, and control pulse width modulation (PWM) startup and shutdown states of a charging metal oxide semiconductor (MOS) transistor according to the first signal;
a discharging control unit, wherein the main control unit is configured to send a second signal to the discharging control unit according to the equalization discharging instruction, the discharging control unit is configured to receive the second signal sent by the main control unit, and control PWM startup and shutdown states of a discharging MOS transistor according to the second signal;
a primary side protection unit, configured to send a first protection signal to the main control unit, so that the main control unit stops outputting the first signal according to the first protection signal; and
a secondary side protection unit, configured to send a second protection signal to the main control unit, so that the main control unit stops outputting the second signal according to the second protection signal.

In an embodiment, the primary side protection unit includes a primary side overcurrent protection unit and a primary side overvoltage protection unit; the primary side overcurrent protection unit is configured to detect a primary side overcurrent signal; after detecting the primary side overcurrent signal, the primary side overcurrent protection unit is configured to send the first protection signal to the main control unit; and

the primary side overvoltage protection unit is configured to detect a primary side overvoltage signal; after detecting the primary side overvoltage signal, the primary side overvoltage protection unit is configured to send the second protection signal to the main control unit.

In an embodiment, the secondary side protection unit includes a secondary side overcurrent protection unit and a secondary side overvoltage protection unit; the secondary side overcurrent protection unit is configured to detect a secondary side overcurrent signal; after detecting the secondary side overcurrent signal, the secondary side overcurrent protection unit is configured to send the second protection signal to the main control unit; and

the secondary side overvoltage protection unit is configured to detect a secondary side overvoltage signal; after detecting the secondary side overvoltage signal, the secondary side overvoltage protection unit is configured to send the first protection signal to the main control unit.

In an embodiment, the active equalization system for the battery further includes:
a current conditioning unit configured to sample an equalization current of the battery;
the main control unit is configured to obtain the equalization current, use the equalization current as a feedback value, and calculate a duty cycle increment of the first signal/second signal based on an enhanced PID algorithm, so that the main control unit sends a first signal with a corrected duty cycle to the charging control unit, or sends a second signal with a corrected duty cycle to the discharging control unit, until the equalization current is controlled within a preset value range to achieve constant current charging or discharging closed-loop regulation.

In an embodiment, the charging control unit includes a charging control chip, a charging MOS transistor, a first capacitor and a first diode connected in parallel on a secondary side of an isolation transformer, and a charging and discharging control chip connected between the charging control unit and the discharging control unit;

a first resistor and a second resistor are connected in parallel at both ends of the first capacitor, and a third resistor and a fourth resistor are connected in parallel at both ends of the first resistor and the second resistor; a second capacitor is connected in parallel on the secondary side of the isolation transformer, and a first electrolytic capacitor is connected in parallel at both ends of the second capacitor; a positive electrode of the first electrolytic capacitor is connected to VIN+, and a negative electrode of the first electrolytic capacitor is grounded;

a drain of the charging MOS transistor is connected to an anode of the first diode, and a source of the charging MOS transistor is connected to the second capacitor through a fifth resistor; a sixth resistor is provided between the source and a gate of the charging MOS transistor; the gate of the charging MOS transistor is connected to a seventh resistor and a second diode and then connected to an OUT pin of the discharging control chip, and an eighth resistor is connected in parallel at two ends of the seventh resistor and a cathode of the second diode;

a ninth resistor is connected in parallel at both ends of the fifth resistor, and the fifth resistor and the ninth resistor are connected in common and then connected to a tenth resistor; the second capacitor is connected to the other end of the tenth resistor; a third diode is connected in parallel at both ends of the second capacitor, and an anode of the third diode and the second capacitor are connected and then grounded;

a VDD pin of the charging control chip is connected to a fourth capacitor and then grounded, and a first voltage is connected between the VDD pin and the fourth capacitor; a GND pin of the charging control chip is grounded; an IN+ pin of the charging control chip is connected to an eleventh resistor and then connected to a $PWM2 pin of the main control unit, and a fourth diode is connected in parallel at both ends of the eleventh resistor; the IN+ pin of the discharging control chip is connected to an anode of the fourth diode and then connected in common to a fifth capacitor, and the other end of the fifth capacitor is grounded;

an IN− pin of the charging control chip is connected to a first MOS transistor; a drain of the first MOS transistor is connected to an IN− pin of the discharging control chip, a source of the first MOS transistor is grounded, and a gate of the first MOS transistor is connected to the primary side protection unit;

a VDD2 pin of the charging and discharging control chip is connected to a third capacitor group and then grounded; a second voltage is connected between the third capacitor group and the VDD2 pin of the charging and discharging control chip, and a second capacitor group comprises a sixth capacitor, a seventh capacitor and an eighth capacitor connected in parallel; and

a GND2 pin of the charging and discharging control chip is grounded; an OUTA pin of the charging and discharging control chip is connected to a twelfth resistor and then connected to the $PWM2 pin of the main control unit, and an INB pin of the charging and discharging control chip is connected to a thirteenth resistor and then connected to the primary side protection unit.

In an embodiment, the discharging control unit includes a first capacitor group, a zener diode group arranged in parallel between a source and a drain of a discharging MOS transistor, and a ninth capacitor and a fifth diode arranged in parallel on a primary side of an isolation transformer; a fourteenth resistor, a fifteenth resistor and a sixteenth resistor are connected in parallel at two ends of the ninth capacitor, and a charging and discharging control chip connected between the charging control unit and the discharging control unit;

the first capacitor group includes a tenth capacitor, an eleventh capacitor, a twelfth capacitor and a thirteenth capacitor arranged in parallel; the zener diode group comprises a first zener diode, a second zener diode and a third zener diode arranged in parallel between the source and the drain of the discharging MOS transistor, and a seventeenth resistor is connected in series between the zener diode group and the first capacitor group after the zener diode group is connected to the source of the discharging MOS transistor;

the resistor is connected to the source of the discharging MOS transistor and then connected in common to an eighteenth resistor; the other end of the eighteenth resistor is connected to a fourteenth capacitor and a sixth diode connected in series at both ends of the fourteenth capacitor, and an anode of the sixth diode is connected to the fourteenth capacitor and then grounded;

a gate of the discharging MOS transistor is connected to a nineteenth resistor and a seventh diode and then connected to an OUT pin of a discharging control chip, and a twentieth resistor is connected in parallel at two ends of the nineteenth resistor and the seventh diode; a twenty-first resistor is connected between the source and the gate of the discharging MOS transistor;

a fifteenth capacitor, a twenty-second resistor and an eighth diode are provided between two ends of the primary side of the isolation transformer; a twenty-third resistor and a twenty-fourth resistor are provided in parallel at both ends of the fifteenth capacitor; a sixteenth capacitor is connected in parallel at both ends of the twenty-fourth resistor, and the sixteenth capacitor and the twenty-fourth resistor are connected in parallel and then connected to a ninth diode; a cathode of the ninth diode is connected to a second voltage, and an anode of the ninth diode is connected to the sixteenth capacitor and then connected to a $VIN_DET24V pin of the main control unit;

a VDD pin of the discharging control chip is connected to a seventeenth capacitor and then grounded, and a first voltage is connected between the VDD pin and the seventeenth capacitor; a GND pin of the discharging control chip is grounded; an IN+ pin of the discharging control chip is connected to a twenty-fifth resistor and connected to a $PWM1 pin of the main control unit, and a twelfth transistor is connected in parallel at both ends of the twenty-fifth resistor; the IN+ pin of the discharging control chip is connected to an anode of the twelfth transistor and then connected in common to an eighteenth capacitor, and the other end of the eighteenth capacitor is grounded;

the IN− pin of the discharging control chip is connected to a second MOS transistor; a drain of the second MOS transistor is connected to the IN− pin of the discharging control chip, a source of the second MOS transistor is grounded, and a gate of the second MOS transistor is connected to the secondary side protection unit;

a VDD1 pin of the charging and discharging control chip is connected to a second capacitor group and then grounded; a second voltage is connected between the second capacitor group and VDD1 pin of the charging and discharging control chip, and the second capacitor group comprises a nineteenth capacitor, a twentieth capacitor and a twenty-first capacitor connected in parallel; and

a GND1 pin of the charging and discharging control chip is grounded, an INA pin of the charging and discharging control chip is connected to a twenty-sixth resistor and then connected to a $PWM2 pin of the main control unit, and an OUTB pin is connected to a twenty-seventh resistor and then connected to the secondary side protection unit.

In an embodiment, the primary side overvoltage protection unit includes a first operational amplifier; a positive side power pin of the first operational amplifier is connected to a second voltage, and a negative side power pin of the first operational amplifier is connected to a twenty-second capacitor; one end of the twenty-second capacitor is connected to the second voltage, and the other end of the twenty-second capacitor is connected to the negative side power pin of the first operational amplifier and then grounded; an output end of the first operational amplifier is connected to the charging control unit, and a twenty-eighth resistor is connected between a non-inverting input end and the output end of the first operational amplifier; one end of the twenty-eighth resistor is connected to the output end of the first operational amplifier, the other end of the twenty-eighth resistor is connected in common to the non-inverting input end of the first operational amplifier and then connected to VREF2; the other end of the twenty-eighth resistor is connected to the non-inverting input end of the first operational amplifier and then connected to a twenty-third capacitor, and the other end of the twenty-third capacitor is grounded; a twenty-fourth capacitor and a twenty-ninth resistor are connected in parallel at a inverting input end of the first operational amplifier; one end of the twenty-fourth capacitor and the twenty-ninth resistor are connected together and then grounded, and the other end of the twenty-fourth capacitor and the twenty-ninth resistor are connected together and then connected to a thirtieth resistor; the thirtieth resistor is connected to VIN+; and

the primary side overcurrent protection unit comprises a second operational amplifier, and an output end of the second operational amplifier is connected to the charging control unit; the output end of the first operational amplifier and the output end of the second operational amplifier are connected and then connected to a thirty-first resistor, and the other end of the thirty-first resistor is connected to the second voltage; a thirty-second resistor is connected between the output end and a non-inverting input end of the second operational amplifier, and the non-inverting input end of the second operational amplifier and the thirty-second resistor are connected and then connected to a twenty-fifth capacitor; the other end of the twenty-fifth capacitor is grounded; the non-inverting input end of the second operational amplifier is connected to the thirty-second resistor and then connected to VREF2, and the inverting input end of the second operational amplifier is connected to the charging control unit.

In an embodiment, the secondary side overvoltage protection unit includes a third operational amplifier; an output end of the third operational amplifier is connected to the discharging control unit, and a thirty-third resistor is connected between the output end and a inverting input end of the third operational amplifier; a positive side power supply pin of the third operational amplifier is connected to the second voltage, and a negative side power supply pin of the third operational amplifier is connected to a twenty-sixth capacitor; one end of the twenty-sixth capacitor is connected to the second voltage, and the other end of the twenty-sixth capacitor is connected to the negative side power supply pin of the third operational amplifier and then grounded; a twenty-seventh capacitor and a thirty-fourth resistor are connected in parallel at the inverting input end of the third operational amplifier; one end of the twenty-seventh capacitor is connected to a thirty-fourth resistor and then grounded, and the other end of the twenty-seventh capacitor is connected to a thirty-fourth resistor and then connected to a thirty-fifth resistor; the other end of the thirty-fifth resistor is connected to the charging control unit;

a twenty-eighth capacitor and a thirty-sixth resistor are connected in parallel at a non-inverting input end of the third operational amplifier; one end of the twenty-eighth capacitor and the thirty-sixth resistor are connected and then grounded, and the other end of the twenty-eighth capacitor and the thirty-sixth resistor are connected and then connected to a thirty-seventh resistor; the other end of the thirty-seventh resistor is connected to a second voltage; a twenty-ninth capacitor is connected to the non-inverting input end of the third operational amplifier, and the other end of the twenty-ninth capacitor is grounded; and

the secondary side overcurrent protection unit comprises a fourth operational amplifier; an output end of the fourth operational amplifier is connected to the discharging control unit, and a thirty-eighth resistor is connected between the output end and a non-inverting input end of the fourth operational amplifier; the output end of the fourth operational amplifier and the thirty-eighth resistor are connected and then connected to a thirty-ninth resistor; one end of the thirty-ninth resistor is connected to the second voltage, and the other end of the thirty-ninth resistor is connected to the output end of the fourth operational amplifier and then connected to the discharging control unit; the inverting input end of the fourth operational amplifier is connected to a $SEC_OCP pin of the main control unit and a thirtieth capacitor; the non-inverting input end of the fourth operational amplifier is connected to a thirty-first capacitor, the thirtieth capacitor is connected to the thirty-first capacitor and then grounded.

In an embodiment, the current conditioning unit includes a fifth operational amplifier and a sixth operational amplifier;

a positive side power supply pin of the fifth operational amplifier is connected to the second voltage, and a negative side power supply pin of the fifth operational amplifier is connected to a third voltage; and a fortieth resistor and a forty-first resistor are connected in series at an output end of the fifth operational amplifier;

a connection node of the fortieth resistor and the forty-first resistor is connected to a thirty-second capacitor, and the other end of the thirty-second capacitor is grounded; the other end of the forty-first resistor is connected to a thirty-third capacitor and an eleventh diode; one end of the thirty-third capacitor is connected to the forty-first resistor, and the other end of the thirty-third capacitor is grounded; a cathode of the eleventh diode is connected to a $BAL-IS pin of the main control unit after being connected to the forty-first resistor, and an anode of the eleventh diode is grounded;

a thirty-fourth capacitor and a forty-second resistor are arranged in parallel between the output end and the inverting input end of the fifth operational amplifier, and the thirty-fourth capacitor is connected to a forty-third resistor after being connected to the forty-second resistor; the other end of the forty-third resistor is grounded; a thirty-fifth capacitor and a forty-fourth resistor are connected in parallel at the inverting input end of the fifth operational amplifier; one end of the thirty-fifth capacitor is connected to a fourth voltage after being connected to the forty-fourth resistor, and the other end of the thirty-fifth capacitor is connected to the forty-fifth resistor after being connected to the forty-fourth resistor; the other end of the forty-fifth resistor is connected to the discharging control unit; and

an output end and a inverting input end of the sixth operational amplifier are connected and then connected to a thirty-sixth capacitor; one end of the thirty-sixth capacitor is connected to a fourth voltage, and the other end of the thirty-sixth capacitor is grounded; a forty-sixth resistor and a thirty-seventh capacitor are connected in parallel at a non-inverting input end of the sixth operational amplifier; one end of the forty-sixth resistor and the thirty-seventh capacitor are connected in common and then grounded, and the other end of the forty-sixth resistor and the thirty-seventh capacitor are connected in common and connected to a forty-seventh resistor; the other end of the forty-seventh resistor is connected to the second voltage.

The present application also provides an active equalization method for a battery, including:

initializing a system clock and analog-to-digital converter (ADC) sampling of the battery;

determining whether an equalization charging instruction/equalization discharging instruction sent by an upper computer is received, and in response to determining that the instruction is not received, continuing to wait for the instruction sent by the upper computer;

in response to determining that the equalization charging instruction/equalization discharging instruction sent by the upper computer is received, controlling a corresponding pin to enable a first signal or a second signal to be output;

obtaining a current equalization current of the battery, configuring the equalization current as a feedback value, and calculating duty cycle increment of the first signal or the second signal based on an enhanced PID algorithm; and

outputting the first signal or the second signal with a corrected duty cycle until a first protection signal or a second protection signal is received, stopping outputting the first signal according to the first protection signal, or stopping outputting the second signal according to the second protection signal to complete active equalization.

Compared with the existing technology, the active equalization system and equalization method for the battery provided by the present application have the following beneficial effects:
The present application provides an active equalization system and equalization method for the battery, which completes charging control, discharging control, primary side overcurrent and overvoltage protection, and secondary side overcurrent and overvoltage protection through a single main control unit. It has a simple structure and low cost. The primary side protection unit and the secondary side protection unit are provided to ensure the safety and reliability of energy transfer of each battery during the active equalization process. The current equalization current of the battery is obtained in real time through the current conditioning unit, and the constant current charging and discharging closed-loop regulation is realized based on the enhanced PID algorithm. The equalization current is used as the feedback value to calculate the duty cycle increment of the control signal, until the equalization current is controlled within the preset value range, the data is real-time, and the closed-loop regulation method makes the voltage equalization between batteries better and the equalization efficiency higher.

### BRIEF DESCRIPTION OF THE DRAWINGS

In order to explain technical solutions in the embodiments of the present application or in the related art more clearly, accompanying drawings needed to be used in the description of the embodiments or the related art will be briefly introduced below. Obviously, the drawings in the following description are only some rather than all of the embodiments of the present application. For those skilled in the art, other drawings obtained based on these drawings, without any creative effort, fall within the scope of the present application.

FIG. 1 is a schematic structural diagram of an active equalization system for a battery according to an embodiment of the present application.

FIG. 2 is a circuit structure diagram of an active equalization system for a battery according to an embodiment of the present application.

FIG. 3 is a circuit structure diagram of a charging control unit in an active equalization system for a battery according to an embodiment of the present application.

FIG. 4 is a circuit structure diagram of a discharging control unit in an active equalization system for a battery according to an embodiment of the present application.

FIG. 5 is a circuit structure diagram of a primary side protection unit in an active equalization system for a battery according to an embodiment of the present application.

FIG. 6 is a circuit structure diagram of a secondary side protection unit in an active equalization system for a battery according to an embodiment of the present application.

FIG. 7 is a circuit structure diagram of a current conditioning unit in an active equalization system for a battery according to an embodiment of the present application.

FIG. 8 is a circuit structure diagram of a main control unit in an active equalization system for a battery according to an embodiment of the present application.

FIG. 9 is a flow chart of an active equalization method for a battery according to an embodiment of the present application.

### DETAILED DESCRIPTION OF EMBODIMENTS

In order to make the purpose, technical solutions and advantages of the present application clearer, the present application will be further described in detail below in conjunction with the accompanying drawings and specific embodiments. It should be understood that the specific embodiments described here are only used to explain the present application and are not used to limit the present application.

In order to make the description of the present application more detailed and complete, an illustrative description of the implementation modes and specific embodiments of the present application is provided below; however, this is not the only form of implementing or using the specific embodiments of the present application. The embodiments cover features of multiple specific embodiments as well as method steps and their sequences for constructing and operating these specific embodiments. However, other specific embodiments may also be used to achieve the same or equivalent functions and step sequences. Based on the embodiments in the present application, all other embodiments obtained by those skilled in the art without creative efforts fall within the scope of the present application.

It should be noted that the terms “first”, “second”, etc. in the description and claims of the present application and the above-mentioned drawings are used to distinguish similar objects and are not necessarily used to describe a specific order or sequence. It should be understood that the data so used are interchangeable under appropriate circumstances so that the embodiments of the present application described herein can be practiced in sequences other than those illustrated or described herein.

In the description of the embodiments of the present application, unless otherwise stated, “/” means or, for example, A/B can mean A or B; “and/or” in the text is just a way to describe the relationship association of associated objects and means that there can be three relationships. For example, A and/or B can mean: A exists alone, A and B exist simultaneously, and B exists alone. In addition, in the description of the embodiment of the present application, “a plurality of” refers to two or more than two, and other quantifiers are similar. It should be understood that the preferred embodiments described here are only used to illustrate and explain the present application, and are not used to limit the present application. In the absence of conflict, the embodiments of the present application and the features in the embodiments can be combined with each other.

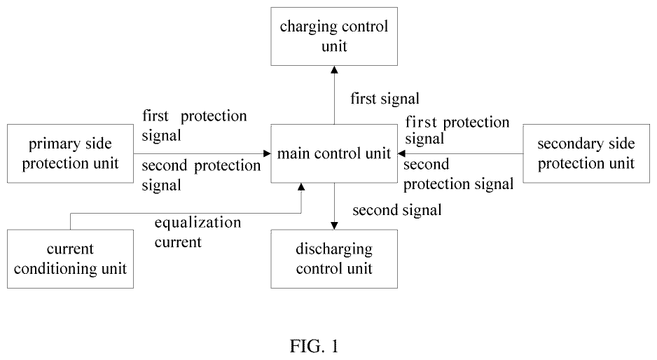

In order to solve the problem of how to simplify the equalization structure of active equalization and improve the safety of active equalization, please refer to FIG. 1 to FIG. 8, an embodiment of the present application provides an active equalization system for a battery. please refer to FIG. 1, which is a schematic structural diagram of an active equalization system for a battery according to an embodiment of the present application, the system includes a main control unit, a charging control unit, a discharging control unit, a primary side protection unit, a secondary side protection unit and a current conditioning unit. In the embodiment of the present application, the above-mentioned main control unit is configured to receive an equalization charging instruction/equalization discharging instruction sent by an upper computer, send a first signal to the charging control unit according to the received equalization charging instruction or equalization discharging instruction, and send a second signal to the discharging control unit. After receiving the first signal sent by the main control unit, the charging control unit controls the pulse width modulation (PWM) start-up and shutdown states of the charging metal oxide semiconductor (MOS) transistor according to the first signal. After receiving the second signal sent by the main control unit, the discharging control unit controls the PWM start-up and shutdown states of the discharging MOS transistor according to the second signal.

Further, the above-mentioned primary side protection unit and secondary side protection unit are configured to send a first protection signal/second protection signal to the main control unit, so that the main control unit stops sending the first signal according to the first protection signal, or the main control unit stop sending the second signal according to the second protection signal.

Specifically, the above-mentioned primary side protection unit includes a primary side overcurrent protection unit and a primary side overvoltage protection unit. The primary side overcurrent protection unit is configured to detect a primary side overcurrent signal. When the primary side overcurrent signal is detected, the first protection signal is sent to the main control unit, so that the main control unit stops sending the first signal according to the first protection signal. The primary side overvoltage protection unit is configured to detect a primary side overvoltage signal. When the primary side overvoltage signal is detected, the second protection signal is sent to the main control unit, so that the main control unit stops sending the second signal according to the second protection signal.

The above-mentioned secondary side protection unit includes a secondary side overcurrent protection unit and a secondary side overvoltage protection unit. The secondary side overvoltage unit is configured to detect a secondary side overvoltage signal. When the secondary side overvoltage signal is detected, the first protection signal is sent to the main control unit, so that the main control unit stops sending the first signal according to the first protection signal, and the overcurrent protection unit is used to detect the secondary side overcurrent signal. When the secondary side overcurrent signal is detected, the second protection signal is sent to the main control unit, so that the main control unit stops sending the second signal according to the second protection signal.

The above-mentioned current conditioning unit is configured to sample the equalization current of the battery and transmit the equalization current obtained by sampling to the main control unit. The main control unit uses the equalization current as a feedback value and calculates the duty cycle increment of the first signal and second signal based on the enhanced proportional integral derivative (PID) algorithm. The first signal after correcting the duty cycle is sent to the charging control unit, and the second signal after correcting the duty cycle is sent to the discharging control unit, to achieve constant current charging closed-loop regulation/constant current discharging closed-loop regulation.

It should be noted that PID is the abbreviation of proportion, integral and derivative, and is collectively known as proportional integral derivative control. A control deviation is formed according to the given value and the actual output value, the deviation is formed the control variables through linear combination according to proportion, integral and differential to control the controlled object. In a specific embodiment provided by the present application, the corrected duty cycle Pout+ calculated based on the enhanced PID is as follows:

$$Err = Vo - Vin \qquad ( 1 )$$

$$Pout += Kp [ Err ( k ) - Err ( k - 1 ) ] + Ki * Err ( k ) + Kd [ Err ( k ) - 2 Err ( k - 1 ) + Err ( k - 2 ) ] \qquad ( 2 )$$

Where Err(k) is the system feedback deviation value last time, Err(k-1) is the system feedback deviation value the last but one time, and so on; the input amount is Vin, the target value is Vo, the feedback deviation is Err, the proportion coefficient is Kp, the integral coefficient is Ki, and the differential coefficient is Kd. Therefore, after the present application calculates the system deviation value Err through formula (1), the system deviation value Err is put into formula (2) to obtain the corrected duty cycle Pout+. The main control unit then sends the first signal with the corrected duty cycle to the charging control unit, and sends the second signal with the corrected duty cycle to the discharging control unit, until the equalization current is controlled within the preset value range to reach the highest equalization efficiency for the battery, thereby achieving constant current charging closed-loop regulation/constant current discharging closed-loop regulation of the battery.

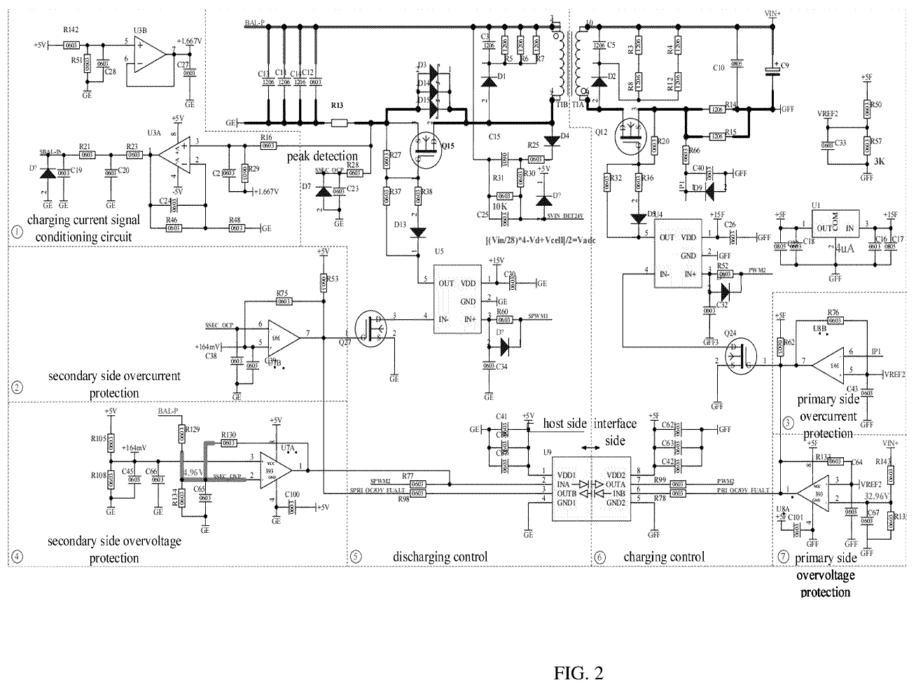

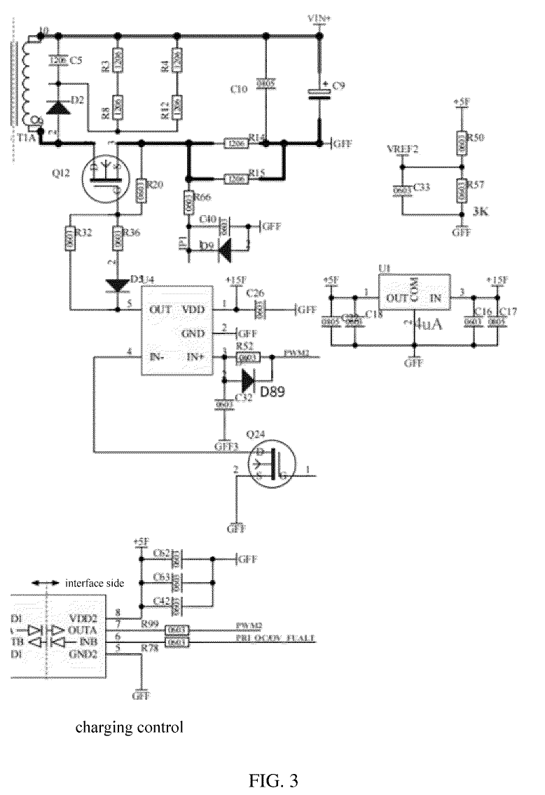

Please refer to FIG. 2, which is a circuit structure diagram of an active equalization system for a battery according to an embodiment of the present application. In a specific embodiment provided by the present application, Please continue to refer to FIG. 3, which is a circuit structure diagram of the charging control unit in an active equalization system for a battery according to an embodiment of the present application, it can be seen that the charging control unit includes a charging control chip, a charging MOS transistor Q12, and a capacitor C5 and a diode D2 connected in parallel on the secondary side TIA of the isolation transformer. Resistors R3 and R8 are connected in parallel at both ends of the capacitor C5. Resistors R4 and R12 are connected in parallel at both ends of the resistors R3 and R8. A capacitor C10 is connected in parallel on the secondary side TIA of the isolation transformer. An electrolytic capacitor C9 is connected in parallel at both ends of the capacitor C10. A positive electrode of the electrolytic capacitor C9 is connected to VIN+, and a negative electrode of the electrolytic capacitor C9 is grounded.

Further, a drain of the charging MOS transistor Q12 is connected to an anode of the diode D2, a source of the charging MOS transistor Q12 is connected to the capacitor C10 through the resistor R14, and a resistor R20 is provided between the source and a gate of the charging MOS transistor Q12. The gate of the charging MOS transistor Q12 is connected to the resistor R36 and diode D5 and then connected to the OUT pin of the discharging control chip. A resistor R32 is connected in parallel at two ends of the resistor R36 and a cathode of the diode D5.

A resistor R15 is connected in parallel at both ends of the resistor R14. After the resistors R14 and R15 are connected together and then connected to a resistor R66. The other end of the resistor R66 is connected to a capacitor C40. A diode D9 is connected in parallel at both ends of the capacitor C40. The anode of the diode D9 is connected to the capacitor C40 and then grounded, the VDD pin of the charging control chip is connected to the capacitor C26 and then grounded, and a first voltage is connected between the VDD pin and the capacitor C26. The GND pin of the charging control chip is grounded. The IN+ pin of the charging control chip is connected to the resistor R52 and then connected to the $PWM2 pin of the main control unit to obtain the first signal PWM2 sent by the main control unit. A diode D89 is connected in parallel at both ends of the resistor R52. The IN+ pin of the discharging control chip is connected to the anode of the diode D89 and then connected in common to the capacitor C32, and the other end of the capacitor C32 is grounded.

Further, the IN− pin of the charging control chip is connected to the MOS transistor Q24, the drain of the MOS transistor Q24 is connected to the IN− pin of the discharging control chip, the source of the MOS transistor Q24 is connected to ground, and the gate of the MOS transistor Q24 is connected to the primary side protection unit. Specifically, the gate of MOS transistor Q24 is connected to an output end of the operational amplifier U8B in the primary side overcurrent protection unit.

A charging and discharging control chip provided between the charging control unit and the discharging control unit is also included, corresponding to the interface side in FIG. 2. The VDD2 pin of the charging and discharging control chip is connected to a third capacitor group and then to ground. A second voltage is connected between the third capacitor group and the VDD2 pin of the charging and discharging control chip. The third capacitor group includes a capacitor C62, a capacitor C63 and a capacitor C42 connected in parallel. The GND2 pin of the charging and discharging control chip is grounded, the OUTA pin of the charging and discharging control chip is connected to the resistor R99 and then connected to the $PWM2 pin of the main control unit, and the INB pin of the charging and discharging control chip is connected to the resistor R78 and then connected to the primary side protection unit. Specifically, the other end of the resistor R78 is connected to the output end of the operational amplifier U8A in the primary side overvoltage protection unit.

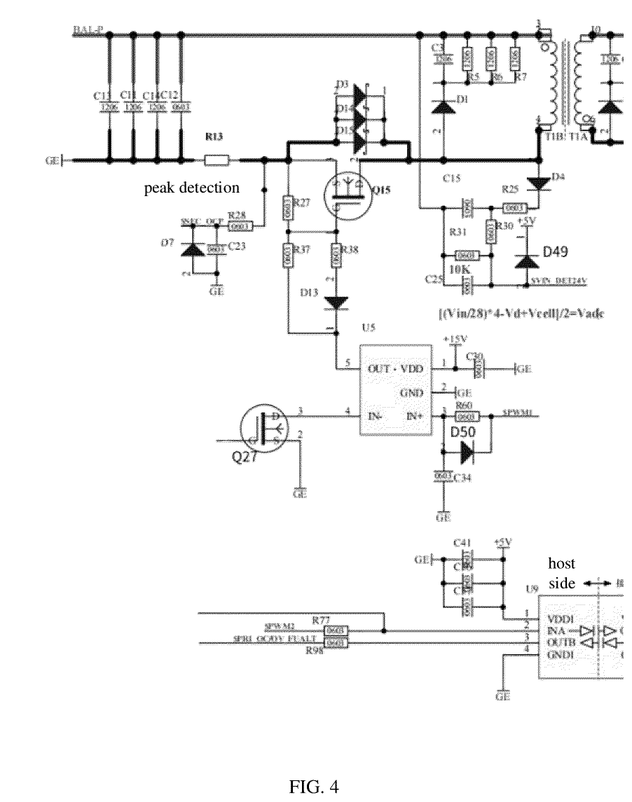

Please refer to FIG. 4, which is a circuit structure diagram of the discharging control unit in an active equalization system for a battery according to an embodiment of the present application. The discharging control unit includes a first capacitor group, a zener diode group arranged in parallel between the source and drain of the discharging MOS transistor Q15, and a capacitor C3 and a diode D1 connected in parallel on the primary side of the isolation transformer. Resistors R5, R6 and R7 are connected in parallel at two ends of the capacitor C3. The first capacitor group includes capacitors C11, C12, C13 and C14 connected in parallel. The zener diode group includes zener diodes D3, D14 and D15 connected in parallel between the source and drain of the discharging MOS transistor Q15. A resistor R13 is connected in series between the zener diode group and the first capacitor group after the zener diode group and the source of the discharging MOS transistor Q15 are connected.

Further, the resistor R13 is connected to the source of the discharging MOS transistor Q15 and then connected in common to the resistor R28. The other end of the resistor R28 is connected to the capacitor C23 and the diode D7 connected in parallel at both ends of the capacitor C23. The anode of the diode D7 is connected to the capacitor C23 and then grounded. The gate of discharging MOS transistor Q15 is connected to the resistor R38 and the diode D13 and then connected to the OUT pin of the discharging control chip. The resistor R37 is connected in parallel at two ends of the resistor R38 and the diode D13. A resistor R27 is connected between the gate and source of the discharging MOS transistor Q15. A capacitor C15, a resistor R25 and a diode D4 are also provided between two ends of the primary side of the isolation transformer T1B. Resistors R30 and R31 are connected in parallel at both ends of the capacitor C15, and a capacitor C25 is connected in parallel at both ends of the resistor R31. The capacitor C25 is connected in parallel to the resistor R31 and then connected to the diode D49. The cathode of the diode D49 is connected to the second voltage, and the anode of the diode D49 is connected to the capacitor C25 and then connected to the $VIN_DET24V pin of the main control unit.

Further, the VDD pin of the discharging control chip is connected to the capacitor C30 and then connected to ground, and the first voltage is connected between the VDD pin and the capacitor C30. The GND pin of the discharging control chip is connected to ground, the IN+ pin of the discharging control chip is connected to the resistor R60 and then connected to the $PWM1 pin of the main control unit. The diode D50 is connected in parallel at both ends of the resistor R60. The IN+ pin of the discharging control chip is connected to the anode of the diode D50 and then connected in common to a capacitor C34, and the other end of the capacitor C34 is connected to ground. The IN− pin of the discharging control chip is connected to the MOS transistor Q27. The drain of the MOS transistor Q27 is connected to the IN− pin of the discharging control chip, the source of the MOS transistor Q27 is connected to ground, and the gate of the MOS transistor Q27 is connected to the secondary side protection unit. Specifically, the gate of MOS transistor Q27 is connected to the output end of the operational amplifier U8B in the secondary side overcurrent protection unit.

A charging and discharging control chip provided between the charging control unit and the discharging control unit is also included, corresponding to the host side and the interface side in FIG. 2. The VDD1 pin of the charging and discharging control chip is connected to a second capacitor group and then connected to ground. A second voltage is connected between the second capacitor group and the VDDI pin of the charging and discharging control chip. The second capacitor group includes capacitors C36, C37 and C41 arranged in parallel. The GND1 pin of the charging and discharging control chip is connected to ground. The INA pin of the discharging control chip is connected to the resistor R77 and then connected to the $PWM2 pin of the main control unit, the OUTB pin of the charging and discharging control chip is connected to the resistor R98 and then connected to the secondary side protection unit. Specifically, the other end of the resistor R98 is connected to the output end of the operational amplifier U8B in the secondary side overcurrent protection unit.

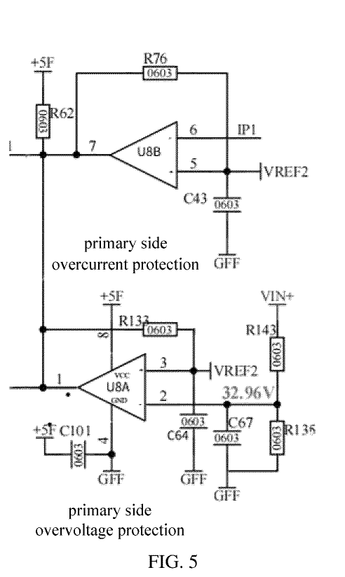

Please refer to FIG. 5, which is a circuit structure diagram of a primary side protection unit in an active equalization system for a battery according to an embodiment of the present application. In a specific embodiment provided by the present application, the primary side overvoltage protection unit includes an operational amplifier U8A, The positive side power supply pin of the operational amplifier U8A is connected to the second voltage, the negative side power supply pin of the operational amplifier USA is connected to a capacitor C101, one end of the capacitor C101 is connected to the second voltage, and the other end of the capacitor C101 is connected to the negative side power supply pin of the operational amplifier USA and then grounded. The output end of the operational amplifier USA is connected to the charging control unit. A resistor R133 is connected between the non-inverting input end and the output end of the operational amplifier U8A, one end of the resistor R133 is connected to the output end of the operational amplifier U8A, and the other end of the resistor R133 is connected to the non-inverting input end of the operational amplifier USA and then connected to VREF2. The other end of the resistor R133 and the non-inverting input end of the operational amplifier U8A are connected in common to the capacitor C64 and then connected to ground. The inverting input end of the operational amplifier U8A is connected to a capacitor C67 and a resistor R135 arranged in parallel. One end of the capacitor C67 is connected to the resistor R135 and then grounded, and the other end of the capacitor C67 is connected to the resistor R135 and then connected to a resistor R143. The resistor R143 is connected to VIN+.

The primary side overcurrent protection unit includes an operational amplifier U8B. The output end of the operational amplifier U8B is connected to the charging control unit. The output end of the operational amplifier USA and the output end of the operational amplifier U8B are connected in common and connected to a resistor R62. The other end of the resistor R62 is connected to the second voltage, and a resistor R67 is connected between the output end and the non-inverting input end of the operational amplifier U8B. The non-inverting input end of the operational amplifier U8B and the resistor R67 are connected in common and connected to a capacitor C43. The other end of the capacitor C43 is grounded. The non-inverting input end of the amplifier U8B and the resistor R67 are connected in common and also connected to VREF2. The inverting input end of the operational amplifier U8B is connected to the charging control unit. Specifically, the inverting input end of the operational amplifier U8B is connected to the gate of the MOS transistor Q24 in the charging control unit.

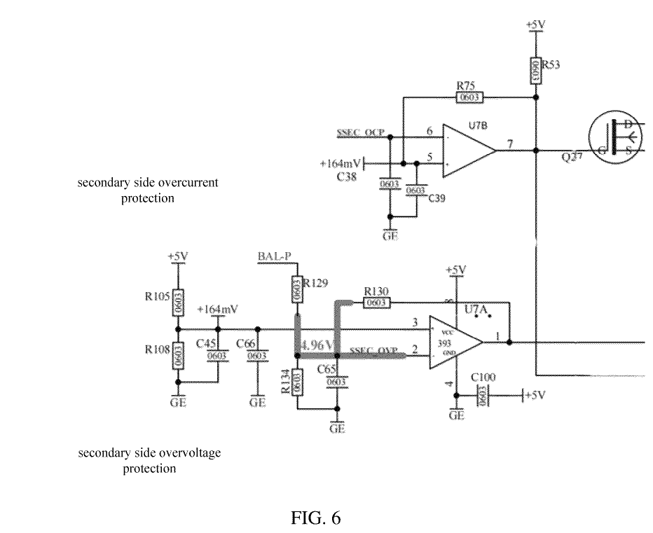

Please refer to FIG. 6, which is a circuit structure diagram of a secondary side protection unit in an active equalization system for a battery according to an embodiment of the present application. In a specific embodiment provided by the present application, the above-mentioned secondary side overvoltage protection unit includes an operational amplifier U7A. The output end of the operational amplifier U7A is connected to the discharging control unit. Specifically, the output end of the operational amplifier UZA is connected to the INA pin of the charging and discharging control chip in the discharging control unit. A resistor R130 is connected between the output end and the inverting input end of the operational amplifier U7A. The positive side power supply pin of the operational amplifier UZA is connected to the second voltage, and the negative side power supply pin of the operational amplifier UTA is connected to the capacitor C100. One end of the capacitor C100 is connected to the second voltage, and the other end of the capacitor C100 is connected to the negative side power supply pin of the operational amplifier U7A and then grounded.

Further, the inverting input end of the operational amplifier UZA is connected to a capacitor C65 and a resistor R134 arranged in parallel. One end of the capacitor C65 and the resistor R134 are connected in common and then connected to ground. The other end of the capacitor C65 and the resistor R134 are connected in common and then connected to the resistor R129. The other end of the resistor R129 is connected to the discharging control unit. Specifically, the other end of the resistor R129 is connected to the first capacitor group in the discharging control unit. The non-inverting input end of the operational amplifier UZA is connected to a capacitor C45 and a resistor R108 arranged in parallel. One end of the capacitor C45 and the resistor R108 are connected in common and then connected to ground. The other end of the capacitor C45 and the resistor R108 are connected in common and then connected to the resistor R105. The other end of the resistor R105 is connected to the second voltage, and the non-inverting input end of the operational amplifier UZA is also connected to a capacitor C66. The other end of the capacitor C66 is grounded.

Please continue to refer to FIG. 6, The secondary side overcurrent protection unit includes an operational amplifier U7B. The output end of the operational amplifier U7B is connected to the discharging control unit. Specifically, the output end of the operational amplifier U7B is connected to the gate of the MOS transistor Q27 in the discharging control unit. A resistor R75 is connected between the output end and the non-inverting input end of the operational amplifier U7B. The output end of operational amplifier U7B and resistor R75 are connected in common and then connected to the resistor R53. One end of the resistor R53 is connected to the second voltage, and the other end of the resistor R53 and the output end of the operational amplifier U7B are connected in common and then connected to the discharging control unit. Specifically, the other end of the resistor R53 and the output end of the operational amplifier U7B are connected in common and then connected to the resistor R98 in the discharging control unit.

Further, the inverting input end of the operational amplifier U7B is connected to the $SEC_OCP pin of the main control unit. The inverting input end of the operational amplifier U7B is connected to the capacitor C38. The non-inverting input end of the operational amplifier U7B is connected to the capacitor C39, and the capacitor C38 is connected to the capacitor C39 and then grounded.

In the embodiment of the present application, the primary side protection unit and the secondary side protection unit belong to hardware protection, and the reference standards of the operational amplifiers U7A, U7B, USA and U8B applied to them are fixed. In practical applications, one input end is generally used as a fixed potential, which is called the basis reference, and the other input end is used as the measured potential. The output end outputs high and low levels according to the relationship between the measured potential and the basis reference, thereby achieving the requirement for the primary side and secondary side protection units to send the first or second protection signals to the main control unit.

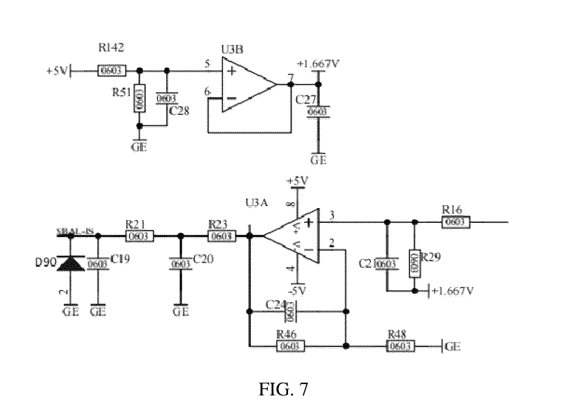

Please continue to refer to FIG. 7, which is a circuit structure diagram of a current conditioning unit in an active equalization system for a battery according to an embodiment of the present application. In a specific embodiment provided by the present application, the above-mentioned current conditioning unit includes an operational amplifier U3A and an operational amplifier U3B. The positive side power supply pin of the operational amplifier U3A is connected to the second voltage, and the negative side power supply pin of the operational amplifier U3A is connected to the third voltage. The resistors R23 and R21 are connected in series at the output end of the operational amplifier U3A, a connection node of the resistors R23 and R21 is connected to a capacitor C20, and the other end of the capacitor C20 is grounded. The other end of the resistor R21 is connected to a capacitor C19 and a diode D90, one end of the capacitor C19 is connected to the resistor R21, and the other end of the capacitor C19 is grounded. The cathode of the diode D90 and the resistor R21 are connected in common and then connected to the $BAL-IS pin of the main control unit, and the anode of diode D90 is grounded.

Further, a capacitor C24 and a resistor R44 are provided in parallel between the output terminal and the inverting input end of the operational amplifier U3A. The capacitor C24 and the resistor R44 are connected in common and then connected to a resistor R48. The other end of the resistor R48 is grounded. The capacitor C21 and the resistor R29 are connected in parallel at the non-inverting input end of the operational amplifier U3A. One end of the capacitor C21 and the resistor R29 are connected in common and then connected to the fourth voltage. The other end of the capacitor C21 and the resistor R29 are connected in common and then connected to a resistor R16. The other end of the resistor R16 is connected to the discharging control unit. Specifically, the other end of the resistor R16 is connected to the connection line of the resistor R13 and the resistor R28 in the discharging control unit.

The output end of the operational amplifier U3B and the inverting input end of the operational amplifier U3B are connected in common and then connected to a capacitor C27, one end of the capacitor C27 is connected to the fourth voltage, and the other end of the capacitor C27 is grounded. The resistor R51 and the capacitor C28 are connected in parallel at the non-inverting input end of the operational amplifier U3B. One end of the resistor R51 and the capacitor C28 are connected in common and then connected to ground. The other end of the resistor R51 and the capacitor C28 are connected in common and then connected to the resistor R142. The other end of the resistor R142 is connected to the second voltage.

It should be noted that the $PWM2 pin in the above-mentioned main control unit is used to output the first signal, i.e., the PWM2 signal, and the $PWM1 pin in the main control unit is used to output the second signal, i.e., the PWM1 signal. The $ represents the function pin that the signal is connected to the main control unit.

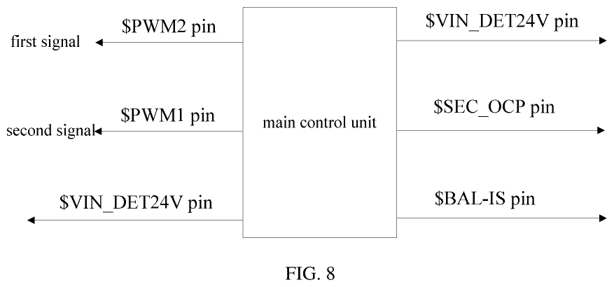

Further, please refer to FIG. 8, which is a circuit structure diagram of a main control unit in an active equalization system for a battery according to an embodiment of the present application. The VDD pin in the main control unit is connected to a capacitor C48 and a capacitor C49 arranged in parallel. One end of the capacitor C48 and the capacitor C49 are connected in common and then grounded, and the other end of the capacitor C48 and capacitor C49 are connected in common and then connected to the second voltage. The VDD15 pin in the main control unit is connected to the capacitor C53 and the capacitor C57 arranged in parallel. The capacitors C53 and C57 are connected in common and then grounded. The NRST pin in the main control unit is connected to the capacitor C46. The other end of the capacitor C46 is connected to ground. A resistor R109 is connected at the connection node of the NRST pin in the main control unit and the capacitor C46, and the other end of the resistor R109 is connected to the second voltage.

In a specific embodiment provided by the present application, the above-mentioned first voltage is preferably set to +15V, the second voltage is preferably set to +5V, the third voltage is preferably set to −5V, and the fourth voltage is preferably set to +1.667 V. The specific values of the above-mentioned first voltage, second voltage, third voltage and fourth voltage can also be adjusted according to actual charging and discharging requirements, which is not limited in the present application.

Next, how to achieve constant current charging closed-loop regulation and constant current discharging closed-loop regulation in the active equalization system for the battery will be described. When receiving the equalization charging instruction sent by the upper computer, the main control unit sends a PWM2 signal with a certain duty cycle to the charging control unit according to the equalization charging instruction, and the charging control unit turns on the charging MOS transistor Q12 according to the PWM2 signal to achieve charging. At the same time, the current conditioning unit samples the equalization current for the current battery, and the main control unit obtains the equalization current and uses it as a feedback value, calculates the duty cycle increment of the PWM2 signal based on the enhanced PID algorithm, and continue to send the PWM2 signal with the corrected duty cycle to the charging control unit until the equalization current is controlled within the preset value range. At the same time, the primary side overcurrent protection unit detects the primary side overcurrent signal, when detecting the primary side overcurrent signal, the primary side overcurrent protection unit sends the first protection signal to the main control unit, causing the main control unit to stop outputting the PWM2 signal. The secondary side overvoltage protection unit detects the secondary side overvoltage protection signal, when detecting the secondary side overvoltage signal, the secondary side overvoltage protection unit sends the first protection signal to the main control unit, causing the main control unit to stop outputting the PWM2 signal, thus realizing the constant current charging closed-loop regulation of the battery.

When receiving the equalization discharging instruction sent by the upper computer, the main control unit sends a PWM1 signal with a certain duty cycle to the discharging control unit according to the equalization discharging instruction, and the discharging control unit turns on the discharging MOS transistor Q15 according to the PWM1 signal to achieve discharge. At the same time, the current conditioning unit samples the equalization current for the current battery. The main control unit obtains the equalization current and uses it as a feedback value, calculates the duty cycle increment of the PWM1 signal based on the enhanced PID algorithm and continues to send the PWM1 signal with the corrected duty cycle to the discharging control unit until the equalization current is controlled within the preset value range. At the same time, the primary side overvoltage protection unit detects the primary side overvoltage signal, when detecting the primary side overvoltage signal, the primary side overvoltage protection unit sends the second protection signal to the main control unit, causing the main control unit to stop outputting the PWM1 signal. The secondary side overcurrent protection unit detects the secondary side overcurrent protection signal, when detecting the secondary side overcurrent signal, the secondary side overcurrent protection unit sends the second protection signal to the main control unit, causing the main control unit to stop outputting the PWM1 signal, thereby realizing the constant current discharging closed-loop regulation of the battery.

It should be noted that during the above-mentioned constant current charging closed-loop regulation, the secondary side overvoltage protection unit and the primary side overcurrent protection unit may function at the same time to send the first protection signal, or only one of the protection units may send the first protection signal. When performing constant current discharging closed-loop regulation, the primary side overvoltage protection unit and the secondary side overcurrent protection unit may also function at the same time to send the second protection signal, or only one of the protection units may send the second protection signal, depending on whether the corresponding signal is detected, which is not limited in the present application.

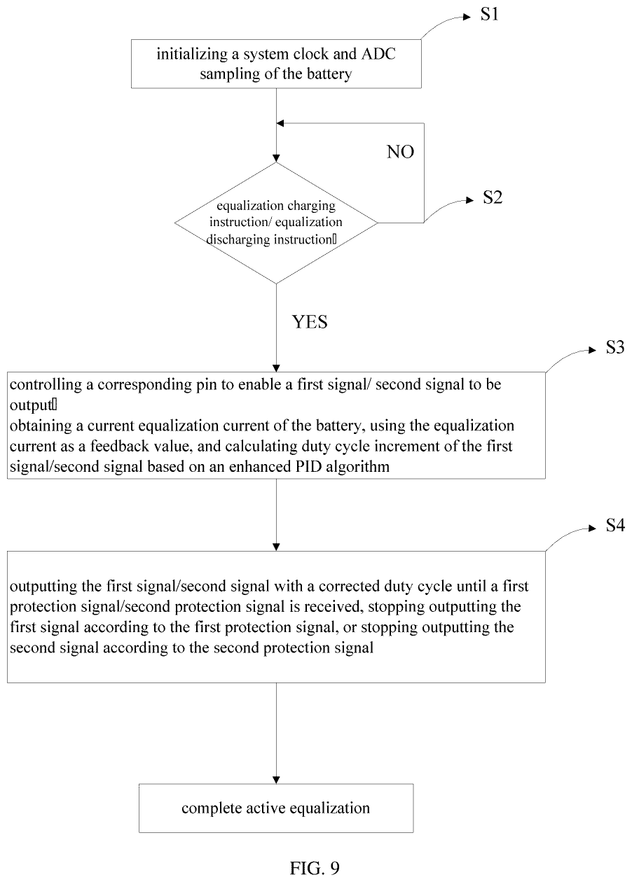

Based on the above-mentioned active equalization system for the battery, the present application also provides an active equalization method for a battery. Please refer to FIG. 9, which is a flow chart of the active equalization method for the battery according to an embodiment of the present application. The method includes the following steps:

S1, initializing a system clock and analog-to-digital converter (ADC) sampling of the battery.

As an optional implementation, before the battery is actively equalized, the main control unit needs to initialize the system clock and ADC sampling of the battery, so that the current conditioning unit can accurately sample the equalization current of the battery.

S2, determining whether the equalization charging instruction/equalization discharging instruction sent by the upper computer is received; if it is determined that the instruction is not received, continuing to wait for the instruction sent by the upper computer.

As an optional implementation, the main control unit determines whether the equalization charging instruction/equalization discharging instruction sent by the upper computer is received. If the instruction is not received, proceeding to step S2 and waiting until the equalization charging instruction/equalization discharging instruction sent by the upper computer is received.

S3, if it is determined that the equalization charging instruction/equalization discharging instruction sent by the upper computer is received, controlling the corresponding pin to enable the first signal/second signal to be output; obtaining the current equalization current of the battery, using the equalization current as the feedback value, and calculating the duty cycle increment of the first signal/second signal based on the enhanced PID algorithm.

As an optional implementation, if the main control unit determines that the equalization charging instruction sent by the upper computer is received, it enables the pin $PWM2corresponding to the current first signal, that is, PWM2, and controls the $PWM2 pin to output the first signal to the charging control unit, so that the charging MOS transistor in the charging control unit controls the PWM start-up and shutdown state of the charging MOS transistor according to the first signal PWM2. Specifically, the charging MOS transistor Q12 is controlled to be turned on to achieve charging, at the same time, the current equalization current of the battery is obtained through the current conditioning unit, the main control unit calculates the duty cycle increment of the first signal in the current state based on the enhanced PID algorithm according to the equalization current, if it is necessary to control the equalization current within the preset value range.

If the main control unit determines that the equalization discharging instruction sent by the upper computer is received, it enables the pin $PWM1 corresponding to the current second signal, that is, PWM1, and controls the $PWM1 pin to output the second signal to the discharging control unit, so that the discharging MOS transistor in the discharging control unit controls the PWM start-up and shutdown state of the discharging MOS transistor according to the second signal PWM1. Specifically, the discharging MOS transistor Q15 is controlled to be turned on to achieve discharge. At the same time, the current equalization current of the battery is obtained through the current conditioning unit. The main control unit calculates the duty cycle increment of the second signal under the current state according to the equalization current and based on the enhanced PID algorithm, if it is necessary to control the equalization current within the preset value range.

It should be noted that when charging according to the equalization charging instruction sent by the upper computer, the MOS transistor Q12 is in the on state and the discharging MOS transistor Q15 is in the off state. When discharging according to the equalization discharging instruction sent by the upper computer, the discharging MOS transistor Q15 is in the on state, and the charging MOS transistor Q12 is in the off state. As for how to realize the switching between the on and off states of the MOS transistor Q12 and the discharging MOS transistor Q15 described above, detailed description has been provided in the active equalization system for the battery in the above embodiments of the present application, and will not be repeated here.

S4, outputting the first signal/second signal with the corrected duty cycle until the first protection signal/second protection signal is received, stopping outputting the first signal according to the first protection signal, or stopping outputting the second signal according to the second protection signal to complete active equalization.

As an optional implementation, when the main control unit receives the equalization charging instruction sent by the upper computer and calculates the duty cycle increment of the first signal in the current state, the main control unit continues to output the first signal with the corrected duty cycle to the charging control unit through the $PWM2 pin, repeats the above process of collecting the current equalization current to calculate the duty cycle increment of the first signal and outputting the first signal with the corrected duty cycle, until the equalization current is controlled within the preset value range.

At the same time, the primary side overcurrent protection unit detects the primary side overcurrent signal. When detecting the primary side overcurrent signal, the primary side overcurrent protection unit sends the first protection signal to the main control unit. The secondary side overvoltage protection unit is used to detect the secondary side overvoltage signal. When detecting the secondary side overvoltage signal, the secondary side overvoltage protection unit also sends the first protection signal to the main control unit. After the main control unit receives the first protection signal sent by the primary side overcurrent protection unit and/or the secondary side overvoltage protection unit, and stops outputting the first signal according to the first protection signal to complete active equalization.

As an optional implementation, when the main control unit receives the equalization discharging instruction sent by the upper computer and calculates the duty cycle increment of the second signal in the current state, the main control unit continues to output the second signal with the corrected duty cycle to the discharging control unit through the $PWM1 pin, repeats the above process of collecting the current equalization current to calculate the duty cycle increment of the second signal and outputting the second signal with the corrected duty cycle, until the equalization current is controlled within the preset value range.

At the same time, the primary side overvoltage protection unit detects the primary side overvoltage signal. When detecting the primary side overvoltage signal, the primary side overvoltage protection unit sends the second protection signal to the main control unit. The secondary side overcurrent protection unit is used to detect the secondary side overcurrent signal. When detecting the secondary side overcurrent signal, the secondary side overcurrent protection unit also sends the second protection signal to the main control unit. After the main control unit receives the second protection signal sent by the primary side overvoltage protection unit and/or the secondary side overcurrent protection unit, and stops outputting the second signal according to the second protection signal to complete active equalization.

It should be noted that the above-mentioned secondary side overvoltage protection unit and the primary side overcurrent protection unit may function at the same time to send the first protection signal, or only one of the protection units may send the first protection signal. The above-mentioned primary side overvoltage protection unit and the secondary side overcurrent protection unit may also function at the same time to send the second protection signal, or only one of the protection units may send the second protection signal, depending on whether the corresponding required signal is detected, which is not limited in the present application.

For other details on how to implement the above-mentioned technical solution in the active equalization method for the battery, please refer to the description of the active equalization system for the battery provided in the above-mentioned embodiments, and will not be repeated here.

In the several embodiments provided in the present application, it should be understood that the disclosed devices, apparatus and methods can be implemented in other ways. For example, the device embodiments described above are only illustrative. For example, the division of units is only a logical function division. In actual implementation, there may be other division methods. For example, multiple units or components may be combined or integrated to another system, or some features can be ignored, or not implemented. On the other hand, the coupling or direct coupling or communication connection between each other shown or discussed may be indirect coupling or communication connection through some interfaces, devices or units, which can be electrical, mechanical or other forms.

In addition, each functional unit in each embodiment of the present application can be integrated into one processing unit, or each unit can exist physically alone, or two or more units can be integrated into one unit. The above integrated units can be implemented in the form of hardware or software functional units.

The present application provides an active equalization system and equalization method for a battery, which completes charging control, discharging control, primary side overcurrent and overvoltage protection, and secondary side overcurrent and overvoltage protection through a single main control unit. It has a simple structure and low cost. The primary side protection unit and the secondary side protection unit are provided to ensure the safety and reliability of energy transfer of each battery during the active equalization process. The current equalization current of the battery is obtained in real time through the current conditioning unit, and the constant current charging and discharging closed-loop regulation is realized based on the enhanced PID algorithm. The equalization current is used as the feedback value to calculate the duty cycle increment of the control signal, until the equalization current is controlled within the preset value range, the data is real-time, and the closed-loop regulation method makes the voltage equalization between batteries better and the equalization efficiency higher.

The above are only some embodiments of the present application and are not intended to limit the present application. Any modifications, equivalent substitutions and improvements made within the spirit and principles of the present application shall be included in the scope of the present application.

What is claimed is:

1. An active equalization system for a battery, comprising:
a main control unit, configured to receive an equalization charging instruction/equalization discharging instruction sent by an upper computer;
a charging control unit, wherein the main control unit is configured to send a first signal to the charging control unit according to the equalization charging instruction, the charging control unit is configured to receive the first signal sent by the main control unit, and control pulse width modulation (PWM) startup and shutdown states of a charging metal oxide semiconductor (MOS) transistor according to the first signal;
a discharging control unit, wherein the main control unit is configured to send a second signal to the discharging control unit according to the equalization discharging instruction, the discharging control unit is configured to receive the second signal sent by the main control unit, and control PWM startup and shutdown states of a discharging MOS transistor according to the second signal;
a primary side protection unit, configured to send a first protection signal to the main control unit, so that the main control unit stops outputting the first signal according to the first protection signal; and
a secondary side protection unit, configured to send a second protection signal to the main control unit, so that the main control unit stops outputting the second signal according to the second protection signal.

2. The active equalization system for the battery of claim 1, wherein the primary side protection unit comprises a primary side overcurrent protection unit and a primary side overvoltage protection unit; the primary side overcurrent protection unit is configured to detect a primary side overcurrent signal; after detecting the primary side overcurrent signal, the primary side overcurrent protection unit is configured to send the first protection signal to the main control unit; and
the primary side overvoltage protection unit is configured to detect a primary side overvoltage signal;
after detecting the primary side overvoltage signal, the primary side overvoltage protection unit is configured to send the second protection signal to the main control unit.

3. The active equalization system for the battery of claim 1, wherein the secondary side protection unit comprises a secondary side overcurrent protection unit and a secondary side overvoltage protection unit; the secondary side overcurrent protection unit is configured to detect a secondary side overcurrent signal; after detecting the secondary side overcurrent signal, the secondary side overcurrent protection unit is configured to send the second protection signal to the main control unit; and
the secondary side overvoltage protection unit is configured to detect a secondary side overvoltage signal; after detecting the secondary side overvoltage signal, the secondary side overvoltage protection unit is configured to send the first protection signal to the main control unit.

4. The active equalization system for the battery of claim 1, further comprising:
a current conditioning unit configured to sample an equalization current of the battery;
wherein the main control unit is configured to obtain the equalization current, use the equalization current as a feedback value, and calculate a duty cycle increment of the first signal/second signal based on an enhanced PID algorithm, so that the main control unit sends a first signal with a corrected duty cycle to the charging control unit, or sends a second signal with a corrected duty cycle to the discharging control unit, until the equalization current is controlled within a preset value range to achieve constant current charging or discharging closed-loop regulation.

5. The active equalization system for the battery of claim 1, wherein the charging control unit comprises a charging control chip, a charging MOS transistor, a first capacitor and a first diode connected in parallel on a secondary side of an isolation transformer, and a charging and discharging control chip connected between the charging control unit and the discharging control unit;
a first resistor and a second resistor are connected in parallel at both ends of the first capacitor, and a third resistor and a fourth resistor are connected in parallel at both ends of the first resistor and the second resistor; a second capacitor is connected in parallel on the secondary side of the isolation transformer, and a first electrolytic capacitor is connected in parallel at both ends of the second capacitor; a positive electrode of the first electrolytic capacitor is connected to VIN+, and a negative electrode of the first electrolytic capacitor is grounded;
a drain of the charging MOS transistor is connected to an anode of the first diode, and a source of the charging MOS transistor is connected to the second capacitor through a fifth resistor; a sixth resistor is provided between the source and a gate of the charging MOS transistor; the gate of the charging MOS transistor is connected to a seventh resistor and a second diode and then connected to an OUT pin of the discharging control chip, and an eighth resistor is connected in parallel at two ends of the seventh resistor and a cathode of the second diode;
a ninth resistor is connected in parallel at both ends of the fifth resistor, and the fifth resistor and the ninth resistor are connected in common and then connected to a tenth resistor; the second capacitor is connected to the other end of the tenth resistor; a third diode is connected in parallel at both ends of the second capacitor, and an anode of the third diode and the second capacitor are connected and then grounded;
a VDD pin of the charging control chip is connected to a fourth capacitor and then grounded, and a first voltage is connected between the VDD pin and the fourth capacitor; a GND pin of the charging control chip is grounded; an IN+ pin of the charging control chip is connected to an eleventh resistor and then connected to a $PWM2 pin of the main control unit, and a fourth diode is connected in parallel at both ends of the eleventh resistor; the IN+ pin of the discharging control chip is connected to an anode of the fourth diode and then connected in common to a fifth capacitor, and the other end of the fifth capacitor is grounded;
an IN− pin of the charging control chip is connected to a first MOS transistor; a drain of the first MOS transistor is connected to an IN− pin of the discharging control chip, a source of the first MOS transistor is grounded, and a gate of the first MOS transistor is connected to the primary side protection unit;
a VDD2 pin of the charging and discharging control chip is connected to a third capacitor group and then grounded; a second voltage is connected between the third capacitor group and the VDD2 pin of the charging and discharging control chip, and a second capacitor group comprises a sixth capacitor, a seventh capacitor and an eighth capacitor connected in parallel; and
a GND2 pin of the charging and discharging control chip is grounded; an OUTA pin of the charging and discharging control chip is connected to a twelfth resistor and then connected to the $PWM2 pin of the main control unit, and an INB pin of the charging and discharging control chip is connected to a thirteenth resistor and then connected to the primary side protection unit.

6. The active equalization system for the battery of claim 1, wherein the discharging control unit comprises a first capacitor group, a zener diode group arranged in parallel between a source and a drain of a discharging MOS transistor, and a ninth capacitor and a fifth diode arranged in parallel on a primary side of an isolation transformer; a fourteenth resistor, a fifteenth resistor and a sixteenth resistor are connected in parallel at two ends of the ninth capacitor, and a charging and discharging control chip connected between the charging control unit and the discharging control unit;
the first capacitor group comprises a tenth capacitor, an eleventh capacitor, a twelfth capacitor and a thirteenth capacitor arranged in parallel; the zener diode group comprises a first zener diode, a second zener diode and a third zener diode arranged in parallel between the source and the drain of the discharging MOS transistor, and a seventeenth resistor is connected in series between the zener diode group and the first capacitor group after the zener diode group is connected to the source of the discharging MOS transistor;
the resistor is connected to the source of the discharging MOS transistor and then connected in common to an eighteenth resistor; the other end of the eighteenth resistor is connected to a fourteenth capacitor and a sixth diode connected in series at both ends of the fourteenth capacitor, and an anode of the sixth diode is connected to the fourteenth capacitor and then grounded;
a gate of the discharging MOS transistor is connected to a nineteenth resistor and a seventh diode and then connected to an OUT pin of a discharging control chip, and a twentieth resistor is connected in parallel at two ends of the nineteenth resistor and the seventh diode; a twenty-first resistor is connected between the source and the gate of the discharging MOS transistor;
a fifteenth capacitor, a twenty-second resistor and an eighth diode are provided between two ends of the primary side of the isolation transformer; a twenty-third resistor and a twenty-fourth resistor are provided in parallel at both ends of the fifteenth capacitor; a sixteenth capacitor is connected in parallel at both ends of the twenty-fourth resistor, and the sixteenth capacitor and the twenty-fourth resistor are connected in parallel and then connected to a ninth diode; a cathode of the ninth diode is connected to a second voltage, and an anode of the ninth diode is connected to the sixteenth capacitor and then connected to a $VIN_DET24V pin of the main control unit;
a VDD pin of the discharging control chip is connected to a seventeenth capacitor and then grounded, and a first voltage is connected between the VDD pin and the seventeenth capacitor; a GND pin of the discharging control chip is grounded; an IN+ pin of the discharging control chip is connected to a twenty-fifth resistor and connected to a $PWM1 pin of the main control unit, and a twelfth transistor is connected in parallel at both ends of the twenty-fifth resistor; the IN+ pin of the discharging control chip is connected to an anode of the twelfth transistor and then connected in common to an eighteenth capacitor, and the other end of the eighteenth capacitor is grounded;
the IN− pin of the discharging control chip is connected to a second MOS transistor; a drain of the second MOS transistor is connected to the IN− pin of the discharging control chip, a source of the second MOS transistor is grounded, and a gate of the second MOS transistor is connected to the secondary side protection unit;
a VDDI pin of the charging and discharging control chip is connected to a second capacitor group and then grounded; a second voltage is connected between the second capacitor group and VDD1 pin of the charging and discharging control chip, and the second capacitor group comprises a nineteenth capacitor, a twentieth capacitor and a twenty-first capacitor connected in parallel; and
a GND1 pin of the charging and discharging control chip is grounded, an INA pin of the charging and discharging control chip is connected to a twenty-sixth resistor and then connected to a $PWM2 pin of the main control unit, and an OUTB pin is connected to a twenty-seventh resistor and then connected to the secondary side protection unit.

7. The active equalization system for the battery of claim 2, wherein the primary side overvoltage protection unit comprises a first operational amplifier; a positive side power pin of the first operational amplifier is connected to a second voltage, and a negative side power pin of the first operational amplifier is connected to a twenty-second capacitor; one end of the twenty-second capacitor is connected to the second voltage, and the other end of the twenty-second capacitor is connected to the negative side power pin of the first operational amplifier and then grounded; an output end of the first operational amplifier is connected to the charging control unit, and a twenty-eighth resistor is connected between a non-inverting input end and the output end of the first operational amplifier; one end of the twenty-eighth resistor is connected to the output end of the first operational amplifier, the other end of the twenty-eighth resistor is connected in common to the non-inverting input end of the first operational amplifier and then connected to VREF2; the other end of the twenty-eighth resistor is connected to the non-inverting input end of the first operational amplifier and then connected to a twenty-third capacitor, and the other end of the twenty-third capacitor is grounded; a twenty-fourth capacitor and a twenty-ninth resistor are connected in parallel at a inverting input end of the first operational amplifier; one end of the twenty-fourth capacitor and the twenty-ninth resistor are connected together and then grounded, and the other end of the twenty-fourth capacitor and the twenty-ninth resistor are connected together and then connected to a thirtieth resistor; the thirtieth resistor is connected to VIN+; and
the primary side overcurrent protection unit comprises a second operational amplifier, and an output end of the second operational amplifier is connected to the charging control unit; the output end of the first operational amplifier and the output end of the second operational amplifier are connected and then connected to a thirty-first resistor, and the other end of the thirty-first resistor is connected to the second voltage; a thirty-second resistor is connected between the output end and a non-inverting input end of the second operational amplifier, and the non-inverting input end of the second operational amplifier and the thirty-second resistor are connected and then connected to a twenty-fifth capacitor; the other end of the twenty-fifth capacitor is grounded; the non-inverting input end of the second operational amplifier is connected to the thirty-second resistor and then connected to VREF2, and the inverting input end of the second operational amplifier is connected to the charging control unit.

8. The active equalization system for the battery of claim 3, wherein the secondary side overvoltage protection unit comprises a third operational amplifier; an output end of the third operational amplifier is connected to the discharging control unit, and a thirty-third resistor is connected between the output end and a inverting input end of the third operational amplifier; a positive side power supply pin of the third operational amplifier is connected to the second voltage, and a negative side power supply pin of the third operational amplifier is connected to a twenty-sixth capacitor; one end of the twenty-sixth capacitor is connected to the second voltage, and the other end of the twenty-sixth capacitor is connected to the negative side power supply pin of the third operational amplifier and then grounded; a twenty-seventh capacitor and a thirty-fourth resistor are connected in parallel at the inverting input end of the third operational amplifier; one end of the twenty-seventh capacitor is connected to a thirty-fourth resistor and then grounded, and the other end of the twenty-seventh capacitor is connected to a thirty-fourth resistor and then connected to a thirty-fifth resistor; the other end of the thirty-fifth resistor is connected to the charging control unit;
a twenty-eighth capacitor and a thirty-sixth resistor are connected in parallel at a non-inverting input end of the third operational amplifier; one end of the twenty-eighth capacitor and the thirty-sixth resistor are connected and then grounded, and the other end of the twenty-eighth capacitor and the thirty-sixth resistor are connected and then connected to a thirty-seventh resistor; the other end of the thirty-seventh resistor is connected to a second voltage; a twenty-ninth capacitor is connected to the non-inverting input end of the third operational amplifier, and the other end of the twenty-ninth capacitor is grounded; and
the secondary side overcurrent protection unit comprises a fourth operational amplifier; an output end of the fourth operational amplifier is connected to the discharging control unit, and a thirty-eighth resistor is connected between the output end and a non-inverting input end of the fourth operational amplifier; the output end of the fourth operational amplifier and the thirty-eighth resistor are connected and then connected to a thirty-ninth resistor; one end of the thirty-ninth resistor is connected to the second voltage, and the other end of the thirty-ninth resistor is connected to the output end of the fourth operational amplifier and then connected to the discharging control unit; the inverting input end of the fourth operational amplifier is connected to a $SEC_OCP pin of the main control unit and a thirtieth capacitor; the non-inverting input end of the fourth operational amplifier is connected to a thirty-first capacitor, the thirtieth capacitor is connected to the thirty-first capacitor and then grounded.

9. The active equalization system for the battery of claim 4, wherein the current conditioning unit comprises a fifth operational amplifier and a sixth operational amplifier;
a positive side power supply pin of the fifth operational amplifier is connected to the second voltage, and a negative side power supply pin of the fifth operational amplifier is connected to a third voltage; and a fortieth resistor and a forty-first resistor are connected in series at an output end of the fifth operational amplifier;
a connection node of the fortieth resistor and the forty-first resistor is connected to a thirty-second capacitor, and the other end of the thirty-second capacitor is grounded; the other end of the forty-first resistor is connected to a thirty-third capacitor and an eleventh diode; one end of the thirty-third capacitor is connected to the forty-first resistor, and the other end of the thirty-third capacitor is grounded; a cathode of the eleventh diode is connected to a $BAL-IS pin of the main control unit after being connected to the forty-first resistor, and an anode of the eleventh diode is grounded;
a thirty-fourth capacitor and a forty-second resistor are arranged in parallel between the output end and the inverting input end of the fifth operational amplifier, and the thirty-fourth capacitor is connected to a forty-third resistor after being connected to the forty-second resistor; the other end of the forty-third resistor is grounded; a thirty-fifth capacitor and a forty-fourth resistor are connected in parallel at the inverting input end of the fifth operational amplifier; one end of the thirty-fifth capacitor is connected to a fourth voltage after being connected to the forty-fourth resistor, and the other end of the thirty-fifth capacitor is connected to the forty-fifth resistor after being connected to the forty-fourth resistor; the other end of the forty-fifth resistor is connected to the discharging control unit; and
an output end and a inverting input end of the sixth operational amplifier are connected and then connected to a thirty-sixth capacitor; one end of the thirty-sixth capacitor is connected to a fourth voltage, and the other end of the thirty-sixth capacitor is grounded; a forty-sixth resistor and a thirty-seventh capacitor are connected in parallel at a non-inverting input end of the sixth operational amplifier; one end of the forty-sixth resistor and the thirty-seventh capacitor are connected in common and then grounded, and the other end of the forty-sixth resistor and the thirty-seventh capacitor are connected in common and connected to a forty-seventh resistor; the other end of the forty-seventh resistor is connected to the second voltage.

10. An active equalization method for a battery; comprising;
initializing a system clock and analog-to-digital converter (ADC) sampling of the battery;
determining whether an equalization charging instruction/equalization discharging instruction sent by an upper computer is received, and in response to determining that the instruction is not received, continuing to wait for the instruction sent by the upper computer;
in response to determining that the equalization charging instruction/equalization discharging instruction sent by the upper computer is received, controlling a corresponding pin to enable a first signal or a second signal to be output;
obtaining a current equalization current of the battery, configuring the equalization current as a feedback value, and calculating duty cycle increment of the first signal or the second signal based on an enhanced PID algorithm; and
outputting the first signal or the second signal with a corrected duty cycle until a first protection signal or a second protection signal is received, stopping outputting the first signal according to the first protection signal, or stopping outputting the second signal according to the second protection signal to complete active equalization.
